(19) United States
(12) Patent Application Publication
(10) Pub. No.: US 2025/0110509 A1
(43) Pub. Date: Apr. 3, 2025

(54) MOBILE INTEGRATED FIELD-DEPLOYED TASK-BASED EQUIPMENT AUTOMATION SYSTEM

(71) Applicant: CenturyLink Intellectual Property LLC, Denver, CO (US)

(72) Inventor: William R. Benassi, Elk River, MN (US)

(73) Assignee: CenturyLink Intellectual Property LLC, Denver, CO (US)

(21) Appl. No.: 18/808,472

(22) Filed: Aug. 19, 2024

Related U.S. Application Data
(60) Provisional application No. 63/587,534, filed on Oct. 3, 2023.

(51) Int. Cl. G05D 1/648; G05D 107/20

(52) U.S. Cl. CPC G05D 1/648; G05D 2107/21

(57) ABSTRACT

Novel tools and techniques are provided for implementing mobile integrated field-deployed task-based equipment automation system. In various embodiments, a system includes autonomous mobile field equipment systems, an equipment transport system, and a system orchestrator. The system orchestrator is configured to deploy, control, and coordinate the equipment transport system to transport, load, deploy, and receive autonomous mobile field equipment systems, and configured to deploy, control, and coordinate each autonomous mobile field equipment systems to perform the tasks within a deployment location. Each autonomous mobile field equipment system includes a propulsion system, a set(s) of task-based actuators, sensors, a computing system, a communications system, and a power supply system. The set(s) of task-based actuators is configured to perform a set of tasks. The computing system is configured to control and coordinate the propulsion system and/or the set(s) of task-based actuators, based at least in part on sensor data collected by the sensors.

### CROSS-REFERENCE TO RELATED APPLICATIONS

This application claims the benefit of U.S. Provisional Application No. 63/587,534 filed Oct. 3, 2023, by William R. Benassi, entitled “Mobile Integrated Field-Deployed Task-Based Equipment Automation System,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing network-enhanced autonomous equipment functionality, particularly, to methods, systems, and apparatuses for implementing mobile integrated field-deployed task-based equipment automation system, and more particularly, to methods, systems, and apparatuses for implementing mobile integrated field-deployed agricultural equipment automation system for a multi-farm, travelling farmer implementation.

### BACKGROUND

In conventional agricultural fields, although some equipment are computer-assisted, tasks such as planting and harvesting are typically performed with hands-on control by human users. Such equipment includes large machines that are costly to manufacture and maintain. Non-agricultural tasks that utilize machines (such as cleanup tasks, etc.) are similarly typically human-powered and/or utilize costly machines. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing mobile integrated field-deployed task-based equipment automation system, in accordance with various embodiments.

FIGS. 2A and 2B depict various example systems and corresponding components for implementing mobile integrated field-deployed task-based equipment automation system, in accordance with various embodiments.

FIG. 3 depicts a schematic diagram illustrating a non-limiting example of a geographic area in which mobile integrated field-deployed task-based equipment automation system may be implemented, in accordance with various embodiments.

FIGS. 4A-4C depicts flow diagrams illustrating a method for implementing mobile integrated field-deployed task-based equipment automation system, in accordance with various embodiments.

FIG. 5 depicts a block diagram illustrating an exemplary computer or system hardware architecture, in accordance with various embodiments.

### DETAILED DESCRIPTION OF CERTAIN EMBODIMENTS

### Overview

Various embodiments provide tools and techniques for implementing network-enhanced autonomous equipment functionality, particularly, to methods, systems, and apparatuses for implementing mobile integrated field-deployed task-based equipment automation system, and more particularly, to methods, systems, and apparatuses for implementing mobile integrated field-deployed agricultural equipment automation system for a multi-farm, travelling farmer implementation.

In various embodiments, a system includes one or more autonomous mobile field equipment systems and a system orchestrator. The system orchestrator is configured to deploy, control, and coordinate each of the one or more autonomous mobile field equipment systems to perform the tasks within a deployment location. Each autonomous mobile field equipment system includes a field equipment propulsion system, one or more sets of task-based actuators, one or more field equipment sensors, a field equipment computing system, a field equipment communications system, and a field equipment power supply system. The field equipment propulsion system is configured to propel said autonomous mobile field equipment system throughout the deployment location. The one or more sets of task-based actuators are each configured to perform a set of tasks. The one or more field equipment sensors are configured to collect sensor data. The field equipment computing system is configured to control and coordinate at least one of the field equipment propulsion system or the one or more sets of task-based actuators, based at least in part on sensor data collected by the one or more field equipment sensors. The field equipment communications system is configured to handle communications between the field equipment computing system and the system orchestrator, the communications including receiving instructions to perform tasks within the deployment location and sending status updates and sensor data. The field equipment power supply system is configured to supply power to at least one of the field equipment propulsion system, the one or more sets of task-based actuators, the one or more field equipment sensors, the field equipment computing system, or the field equipment communications system, and/or the like.

In some embodiments, the system further includes an equipment transport system that is configured to transport the one or more autonomous mobile field equipment systems and to traverse from one deployment location to another deployment location, the equipment transport system including a loading section that is configured to load, deploy, and receive the one or more autonomous mobile field equipment systems. In some examples, the system further includes one or more field equipment docking stations, each configured to provide electrical power to one of the one or more autonomous mobile field equipment systems via connection with a power source. Each field equipment docking station includes at least one docking port each configured to electrically couple with one of the one or more autonomous mobile field equipment systems.

In some embodiments, the one or more sets of task-based actuators are modular systems that are configured to be interchangeable. In some examples, the deployment location includes one of an agricultural site, an emergency site, a nature site, a recreational site, or an event venue, and/or the like. In some instances, the agricultural site includes at least one of an agricultural field, a farm, a plot of land, a ranch, an orchard, a crop field, or a sod field, and/or the like. In some cases, the emergency site includes one of a site of a natural disaster, an accident site, a hazardous waste spill site, or a search and rescue site, and/or the like. In examples, the nature site includes one of a forest, a field, a meadow, an aquatic site, or an orbital site, and/or the like. In some cases, the recreational site includes one of a park, a plant garden, a flower garden, a plant nursery, a botanical garden, a residential lawn, a commercial lawn, a residential garden, a commercial garden, a greenway, or a recreational center, and/or the like. In some instances, the event venue includes one of a stadium, a concert hall, an arena, or a festival site, and/or the like.

The various embodiments provide for autonomous mobile field equipment systems that perform tasks without much human intervention, based on instructions provided by a system orchestrator(s). The equipment transport system—which transports, loads, deploys, and receives the autonomous mobile field equipment systems—may be human-driven or autonomous. In some cases, swarms of these autonomous mobile field equipment systems may be deployed using one or more equipment transport systems. In some embodiments, these autonomous mobile field equipment systems may be manufactured at lower cost compared with conventional large machine-based agricultural or non-agricultural equipment. Accordingly, efficiency, lower costs, and consistency may be achieved.

These and other aspects of the mobile integrated field-deployed task-based equipment automation system are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a system, which includes one or more autonomous mobile field equipment systems and a system orchestrator. Each of the one or more autonomous mobile field equipment systems includes a field equipment propulsion system that is configured to propel said autonomous mobile field equipment system throughout a deployment location; one or more sets of task-based actuators that are each configured to perform a set of tasks; and one or more field equipment sensors that are configured to collect sensor data. Each autonomous mobile field equipment system further includes a field equipment computing system that is configured to control and coordinate at least one of the field equipment propulsion system or the one or more sets of task-based actuators, based at least in part on sensor data collected by the one or more field equipment sensors; and a field equipment communications system that is configured to handle communications between the field equipment computing system and the system orchestrator, the communications including receiving instructions to perform tasks within the deployment location and sending status updates and sensor data. Each autonomous mobile field equipment system further includes a field equipment power supply system that is configured to supply power to at least one of the field equipment propulsion system, the one or more sets of task-based actuators, the one or more field equipment sensors, the field equipment computing system, or the field equipment communications system, and/or the like. The system orchestrator is configured to deploy, control, and coordinate each of the one or more autonomous mobile field equipment systems to perform the tasks within the deployment location.

In some embodiments, the system further includes an equipment transport system that is configured to transport the one or more autonomous mobile field equipment systems and to traverse from one deployment location to another deployment location, the equipment transport system including a loading section that is configured to load, deploy, and receive the one or more autonomous mobile field equipment systems. In some examples, the system further includes one or more field equipment docking stations, each configured to provide electrical power to one of the one or more autonomous mobile field equipment systems via connection with a power source. Each field equipment docking station includes at least one docking port each configured to electrically couple with one of the one or more autonomous mobile field equipment systems.

In an example, the power source includes one of at least one onsite power source that is disposed within the deployment location. In such cases, each field equipment docking station further includes at least one power connector each configured to electrically couple with the one of the at least one onsite power source that is disposed within the deployment location; and a docking station propulsion system that is configured to propel the at least one docking station between the equipment transport system and the one of the at least one onsite power source. In some cases, the at least one onsite power source includes an array of solar panels that is permanently installed at the deployment location. In another example, the power source includes one of at least one deployable power source, each deployable power source including a solar powered generator that is configured to be deployed, by the equipment transport system, to at least one docking position within the deployment location. In some instances, each of the one or more field equipment docking stations is coupled with a corresponding one of the at least one deployable power source before or after being deployed to the at least one set position. In such instances, at least one of each field equipment docking station or each deployable power source includes a propulsion system that is configured to propel the at least one of each field equipment docking station or each deployable power source between the equipment transport system and the at least one docking position within the deployment location.

According to some embodiments, the system orchestrator is disposed within the equipment transport system, where the equipment transport system includes a vehicle. In examples, the system orchestrator is external to the one or more autonomous mobile field equipment systems and the equipment transport system, and is configured to communicatively couple with each of the one or more autonomous mobile field equipment systems and the equipment transport system via at least one network connection.

In some embodiments, the one or more sets of task-based actuators are modular systems that are configured to be interchangeable. In some examples, the deployment location includes one of an agricultural site, an emergency site, a nature site, a recreational site, or an event venue, and/or the like. In some instances, the agricultural site includes at least one of an agricultural field, a farm, a plot of land, a ranch, an orchard, a crop field, or a sod field, and/or the like. In some cases, the emergency site includes one of a site of a natural disaster, an accident site, a hazardous waste spill site, or a search and rescue site, and/or the like. In examples, the nature site includes one of a forest, a field, a meadow, an aquatic site, or an orbital site, and/or the like. In some cases, the recreational site includes one of a park, a plant garden, a flower garden, a plant nursery, a botanical garden, a residential lawn, a commercial lawn, a residential garden, a commercial garden, a greenway, or a recreational center, and/or the like. In some instances, the event venue includes one of a stadium, a concert hall, an arena, or a festival site, and/or the like.

In another aspect, the technology relates to a method, which includes instructing, by a computing system, an equipment transport system to traverse to a first deployment location from its current location; instructing, by the computing system, the equipment transport system to deploy, within the first deployment location, one or more autonomous mobile field equipment systems that are loaded within the equipment transport system, after the equipment transport system has arrived at the first deployment location; and instructing, by the computing system, each of the one or more autonomous mobile field equipment systems to perform a corresponding set of tasks, after being deployed to one or more portions of the first deployment location.

In some embodiments, the method further includes sending, by the computing system, one or more messages to at least one user device, the one or more messages including at least one of: a first message for sending after the equipment transport system arrives at the first deployment location, the first message indicating that the equipment transport system has arrived at the first deployment location; a second message for sending after the equipment transport system deploys the one or more autonomous mobile field equipment systems, the second message indicating that the one or more autonomous mobile field equipment systems have been deployed within the first deployment location; a third message for sending after the computing system assigns the corresponding set of tasks to one of the one or more autonomous mobile field equipment systems, the third message indicating that the one of the one or more autonomous mobile field equipment systems has been assigned the corresponding set of tasks; or a fourth message for sending after the computing system receives one or more task status updates from one of the one or more autonomous mobile field equipment systems, the fourth message including the one or more task status updates for the one of the one or more autonomous mobile field equipment systems; and/or the like.

According to some embodiments, the set of tasks each includes at least one of an agriculture task, an emergency response task, a nature conservation task, a nature reclamation task, a nature maintenance task, a recreational area plant task, a recreational area plant watering task, a recreational area plant fertilizing task, a recreational area plant removal task, an object relocation task, a site cleanup task, or a waste removal task, and/or the like.

In some examples, the set of tasks includes a set of agriculture tasks including at least one of preparing for planting, planting, watering, fertilizing, harvesting, or removing one or more of a plurality of seeds or a plurality of plants, and/or the like. In such cases, the method further includes instructing, by the computing system, a first autonomous mobile field equipment system among the one or more autonomous mobile field equipment systems to perform at least one agriculture task among the set of agriculture tasks, by sending at least one of one or more first instructions to prepare a first planting area within the first deployment location for planting; one or more second instructions to plant the one or more of the plurality of seeds or the plurality of plants in the first planting area within the first deployment location; one or more third instructions to water plants within the first planting area; one or more fourth instructions to fertilize plants within the first planting area; one or more fifth instructions to harvest plants within the first planting area; or one or more sixth instructions to remove dead, dying, or undesired plants from the first planting area; and/or the like.

The one or more first instructions include instructions for moving a plurality of planting media to the first planting area; and preparing each of the plurality of planting media for planting. The one or more second instructions include instructions for moving the one or more of the plurality of seeds or the plurality of plants to the first planting area; creating a space within each corresponding portion of the plurality of planting media; inserting the one or more of the plurality of seeds or the plurality of plants in corresponding created spaces of the plurality of planting media; and covering gaps within the created spaces around the inserted one or more of the plurality of seeds or the plurality of plants. The one or more third instructions include instructions for moving to the first planting area with a load of water; and dispensing water to the one or more of the plurality of seeds or the plurality of plants that have been planted in the corresponding plurality of planting media. The one or more fourth instructions include instructions for moving to the first planting area with a load of fertilizer; and dispensing fertilizer to the one or more of the plurality of seeds or the plurality of plants that have been planted in the corresponding plurality of planting media. The one or more fifth instructions include instructions for moving to the first planting area; harvesting harvestable portions of the one or more of the plurality of seeds or the plurality of plants based on a determination that the harvestable portions are ready for harvesting; and moving the harvested harvestable portions to a harvest collection location for loading and transport from the first deployment location. The one or more sixth instructions include instructions for moving to the first planting area; identifying plants for removal from the first planting area; moving to and extracting plants that have been identified for removal; and moving the harvested harvestable portions to a harvest collection location for loading and transport from the first deployment location.

In some examples, the one or more of the plurality of seeds or the plurality of plants are planted in a plurality of straw bales, each straw bale being bundled together to form an integrated structure. An outer surface of the integrated structure forms a container while a middle portion of the integrated structure decomposes to form the plurality of planting media. In examples, the set of tasks is performed using one or more modular and interchangeable sets of task-based actuators. In such examples, the method further includes determining, by the computing system, whether a second autonomous mobile field equipment system is currently equipped with a set of task-based actuators that is capable of performing a currently assigned set of tasks; and based on a determination that a currently equipped set of task-based actuators is not capable of performing the currently assigned set of tasks, instructing, by the computing system, an actuator exchange system to replace the currently equipped set of task-based actuators with a set of task-based actuators that is capable of performing the currently assigned set of tasks.

In some embodiments, the method further includes instructing, by the computing system, each of the one or more autonomous mobile field equipment systems to move to a field equipment docking station to dock with the field equipment docking station to recharge its field equipment power supply, based on a determination that its field equipment power supply is at a power level below a first predetermined threshold level. According to some embodiments, the method further includes instructing, by the computing system, each of the one or more autonomous mobile field equipment systems to return the equipment transport system for reloading, based on a determination that the set of tasks have been completed; instructing, by the computing system, the equipment transport system to receive and load each of the one or more autonomous mobile field equipment systems; and instructing, by the computing system, the equipment transport system to traverse from the first deployment location to one of a base location or a second deployment location.

In yet another aspect, the technology relates to an autonomous mobile field equipment system, which includes a field equipment propulsion system that is configured to propel the autonomous mobile field equipment system throughout a deployment location; one or more sets of task-based actuators that are each configured to perform a set of tasks; one or more field equipment sensors that are configured to collect sensor data; a field equipment computing system that is configured to control and coordinate at least one of the field equipment propulsion system, the one or more sets of task-based actuators, or the one or more field equipment sensors, and/or the like; a field equipment communications system that is configured to handle communications between the field equipment computing system and a system orchestrator; and a field equipment power supply system that is configured to supply power to at least one of the field equipment propulsion system, the one or more sets of task-based actuators, the one or more field equipment sensors, the field equipment computing system, or the field equipment communications system, and/or the like.

According to some embodiments, the set of tasks includes a set of agricultural tasks including at least one of preparing for planting, planting, watering, fertilizing, harvesting, or removing one or more of a plurality of seeds or a plurality of plants, and/or the like. In some examples, the one or more sets of task-based actuators are modular systems that are configured to be interchangeable.

Various modifications and additions can be made to the embodiments discussed without departing from the scope of the invention. For example, while the embodiments described above refer to particular features, the scope of this invention also includes embodiments having different combination of features and embodiments that do not include all of the above-described features.

### Specific Exemplary Embodiments

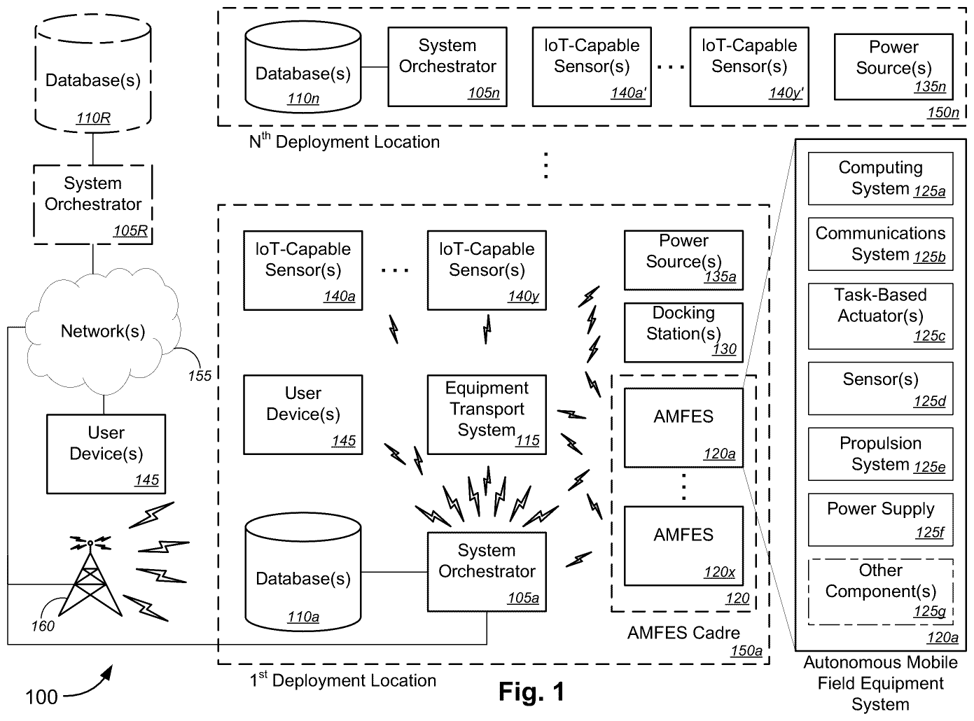

We now turn to the embodiments as illustrated by the drawings. FIGS. 1-5 illustrate some of the features of the method, system, and apparatus for implementing network-enhanced autonomous equipment functionality, particularly, to methods, systems, and apparatuses for implementing mobile integrated field-deployed task-based equipment automation system, and more particularly, to methods, systems, and apparatuses for implementing mobile integrated field-deployed agricultural equipment automation system for a multi-farm, travelling farmer implementation, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 depicts an example system 100 for implementing mobile integrated field-deployed task-based equipment automation system, in accordance with various embodiments.

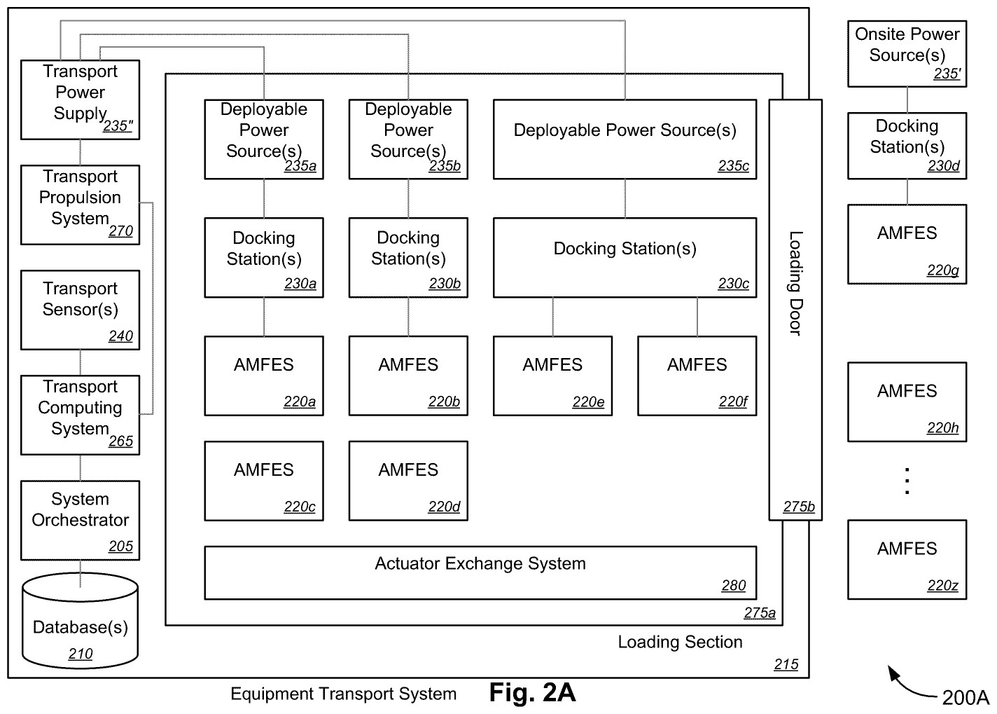

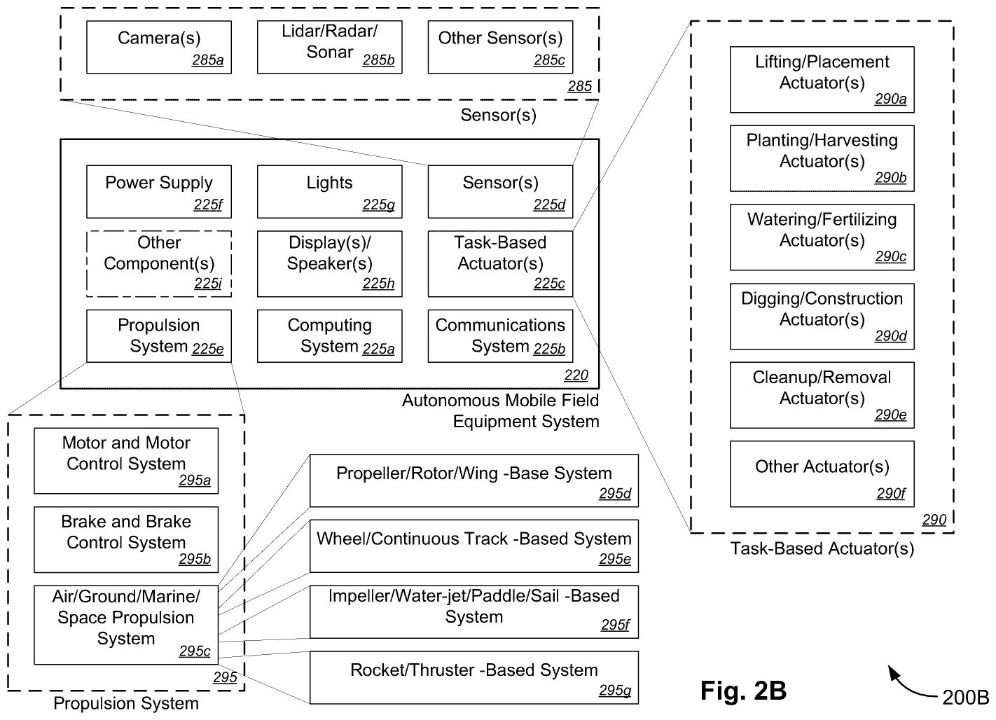

In the non-limiting embodiment of FIG. 1, system 100 may include a system orchestrator 105a and a data store or database 110a that is local to the system orchestrator 105a. In some cases, the database 110a may be external, yet communicatively coupled, to the system orchestrator 105a. In other cases, the database 110a may be integrated within the system orchestrator 105a. System 100 further includes at least one of equipment transport system 115, a plurality of autonomous mobile field equipment systems 120a-120x (collectively, “autonomous mobile field equipment systems 120”) and its components 125, one or more docking stations 130, or one or more power sources 135a, and/or the like. In some embodiments, at least one autonomous mobile field equipment system 120 (e.g., autonomous mobile field equipment system 120a of FIG. 1) may each include at least one of computing system or field equipment computing system 125a, communications system or field equipment communications system 125b, one or more task-based actuators 125c, one or more sensors or field equipment sensors 125d, a propulsion system or field equipment propulsion system 125e, a power supply or field equipment power supply system 125f, or other field equipment components 125g, and/or the like, as shown and described in detail with respect to FIG. 2B. System 100, according to some embodiments, may further include Internet of Things (“IoT”)-capable sensors 140a-140y (collectively, “IoT-capable sensors 140” or the like). In some embodiments, system 100 may further include one or more user devices 145. System 100 extends over a plurality of deployment locations 150a-150n (collectively, “deployment locations 150”).

In some examples, the system orchestrator 105a and corresponding database(s) 110a, the equipment transport system 115, the one or more autonomous mobile field equipment systems 120a-120x, the one or more docking stations 130, the one or more power sources 135a, the one or more IoT-capable sensors 140a-140y, and the one or more user devices 145 may be disposed within a first deployment location 150a among the plurality of deployment locations 150a-150n. In examples, system 100 further includes at least one of system orchestration 105n and corresponding data store or database 110n, one or more IoT-capable sensors 140a′-140y′, or one or more power sources 135n, and/or the like, that, in some cases, may be disposed within an Nth deployment location 150n among the plurality of deployment locations 150a-150n. Although not shown, combinations of two or more of system orchestrator 105 and corresponding database(s) 110, one or more IoT-capable sensors 140, or one or more power sources 135, and/or the like, may be disposed in each of one or more deployment locations 150b-150[n−1]. In examples, the equipment transport system 115, the one or more autonomous mobile field equipment systems 120a-120x, and/or the one or more docking stations 130 may travel or may be transported from one deployment location 150 to another deployment location among the plurality of deployment locations 150a-150n, or may travel or may be transported to or from a base location (not shown). Herein, n, x, y, and y′ are non-negative integer numbers that may be either all the same as each other, all different from each other, or some combination of same and different (e.g., one set of two or more having the same values with the others having different values, a plurality of sets of two or more having the same value with the others having different values, etc.).

In some embodiments, the plurality of deployment locations 150a-150n may each include one of an agricultural site, an emergency site, a nature site, a recreational site, or an event venue, and/or the like. In some instances, the agricultural site includes at least one of an agricultural field, a farm, a plot of land, a ranch, an orchard, a crop field, or a sod field, and/or the like. In some cases, the emergency site includes one of a site of a natural disaster, an accident site, a hazardous waste spill site, or a search and rescue site, and/or the like. In examples, the nature site includes one of a forest, a field, a meadow, an aquatic site, or an orbital site, and/or the like. In some cases, the recreational site includes one of a park, a plant garden, a flower garden, a plant nursery, a botanical garden, a residential lawn, a commercial lawn, a residential garden, a commercial garden, a greenway, or a recreational center, and/or the like. In some instances, the event venue includes one of a stadium, a concert hall, an arena, or a festival site, and/or the like.

System 100 may further include remote system orchestrator 105R and corresponding remote database(s) 110R that communicatively couple, via network(s) 155 (and in some cases, via the one or more telecommunications relay systems 160, either via wireless communications or via a combination of wireless and wired communications), with at least one of the system orchestrators 105a-105n, the equipment transport system 115, the one or more autonomous mobile field equipment system 120a-120x, the one or more docking stations 130, the one or more power sources 135a-135n, the one or more IoT-capable sensors 140a-140y through 140a′-140y′, or the one or more user device 145, and/or the like, that are distributed or disposed across the plurality of deployment locations 150a-150n. In some cases, system orchestrator 105a may wireless communicate with each of the at least one of the one or more power sources 135a and/or the one or more IoT-capable sensors 140a-140y, or the like (as depicted in FIG. 1 by lightning bolt symbols). When the equipment transport system 115, the autonomous mobile field equipment systems 120, the docking stations 130, and/or the user devices 145 are disposed or deployed to or within the first deployment location 150a, system orchestrator 105a may further wirelessly communicate with each of the at least one of the equipment transport system 115, the one or more autonomous mobile field equipment system 120a-120x, the one or more docking stations 130, or the one or more user device 145, and/or the like, (as depicted in FIG. 1 by lightning bolt symbols). Merely by way of example, in some cases, when the equipment transport system 115, the autonomous mobile field equipment systems 120, the docking stations 130, and/or the user devices 145 are disposed or deployed to or within the first deployment location 150a, the system orchestrator 105a may autonomously communicate with each of at least one of the equipment transport system 115, the one or more autonomous mobile field equipment system 120a-120x, the one or more docking stations 130, the one or more power sources 135a, the one or more IoT-capable sensors 140a-140y, or the one or more user device 145, and/or the like, using IoT-based communications protocols and/or network protocols, or the like, including, but not limited to, at least one of Wi-Fi®, Bluetooth™, ZigBee®, Z-Wave®, LoRaWan®, IEEE 802.11ah, IEEE 802.15.4e, etc.

In a similar manner, system orchestrator 105n may wireless communicate with each of the at least one of the one or more power sources 135n and/or the one or more IoT-capable sensors 140a′-140y′, or the like. When the equipment transport system 115, the autonomous mobile field equipment systems 120, the docking stations 130, and/or the user devices 145 are disposed or deployed to or within the Nth deployment location 150n, system orchestrator 105n may further wirelessly communicate with each of the at least one of the equipment transport system 115, the one or more autonomous mobile field equipment system 120a-120x, the one or more docking stations 130, or the one or more user device 145, and/or the like. According to some embodiments, system orchestrator 105a-105n may be a consolidated system orchestrator 105 that is disposed on the equipment transport system 115, rather than disposed on at the corresponding deployment location 150. In some embodiments, rather than system orchestrators 105a-105n being disposed at the plurality of deployment locations 150a-150n and/or disposed on the equipment transport system 115, the remote system orchestrator 105R may be used to control, manage, or otherwise communicate with at least one of the equipment transport system 115, the autonomous mobile field equipment systems 120, the docking station(s) 130, the power source(s) 135, the IoT-capable sensor(s) 140, and/or the user devices 145, via network(s) 155 (and in some cases, via the one or more telecommunications relay systems 160).

In some examples, the IoT-capable sensors 140 and/or the sensors 125d may each include, but is not limited to, at least one of one or more temperature sensors, one or more wind sensors, one or more weather sensors, one or more atmospheric pressure sensors, one or more altitude sensors, one or more geolocation sensors, one or more light sensors, one or more light intensity sensors, one or more image sensors, one or more video sensors, one or more object orientation sensors, one or more surface orientation sensors, one or more motion sensors, one or more infrared sensors, or one or more object detection sensors, and/or the like. In some cases, particularly with land-based use cases (e.g., agricultural use cases, land-based emergency use cases, land-based nature use cases, recreational site use cases, land-based event venue use cases, etc.), the IoT-capable sensors 140 and/or the sensors 125d may each further include, without limitation, at least one of one or more humidity sensors, one or more soil moisture sensors, one or more ground water sensors, one or more slope sensors, one or more topography sensors, one or more water flow sensors, one or more clog sensors, one or more water pump sensors, one or more irrigation system sensors, one or more plant monitoring sensors, one or more weed detectors, or one or more pest detectors, and/or the like. In some instances, particularly with marine-based use cases (e.g., water-based nature site, etc.), the IoT-capable sensors 140 and/or the sensors 125d may each further include, but is not limited to, at least one of one or more water depth sensors, one or more pH sensors, one or more tide sensors, one or more sonar-based detectors, or one or more particulate detectors, and/or the like. In some instances, the one or more user devices 145 may include, but are not limited to, at least one of a desktop computer, a laptop computer, a tablet computer, a smart phone, a mobile phone, a personal digital assistant, or a remote system control device, and/or the like.

According to some embodiments, network(s) 155 may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network(s) 155 may include an access network of the service provider (e.g., an Internet service provider (“ISP”)). In another embodiment, the network(s) 155 may include a core network of the service provider and/or the Internet.

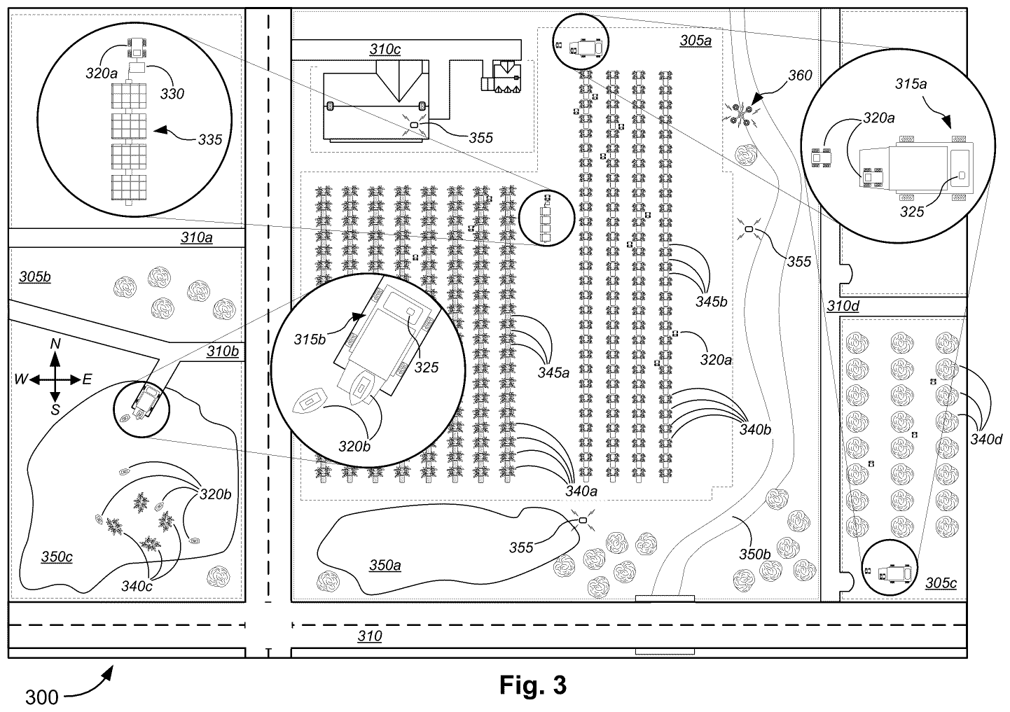

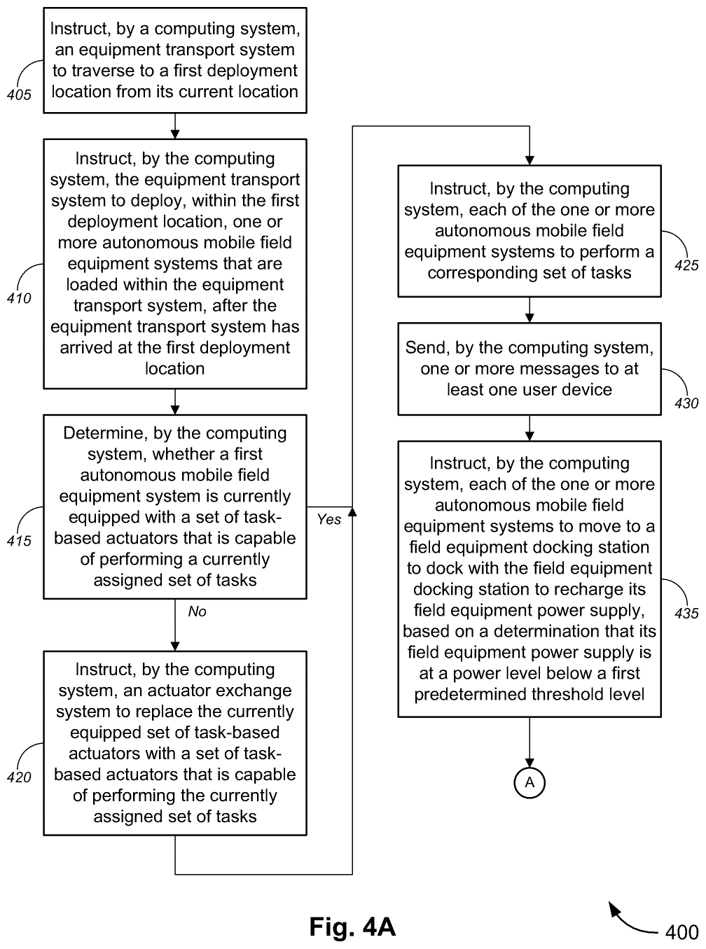

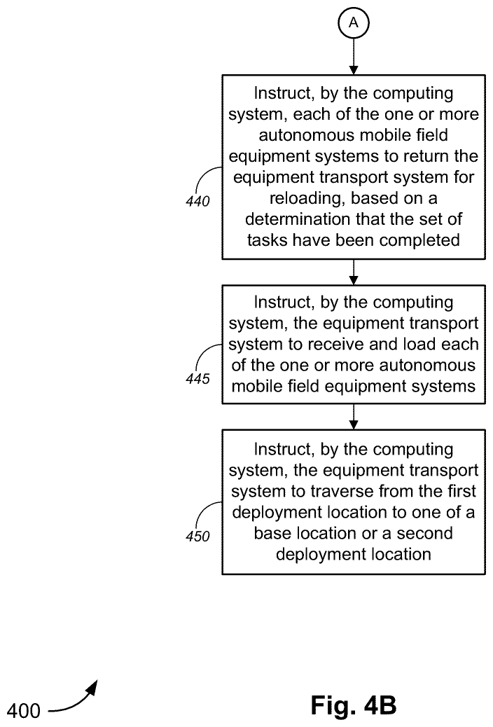

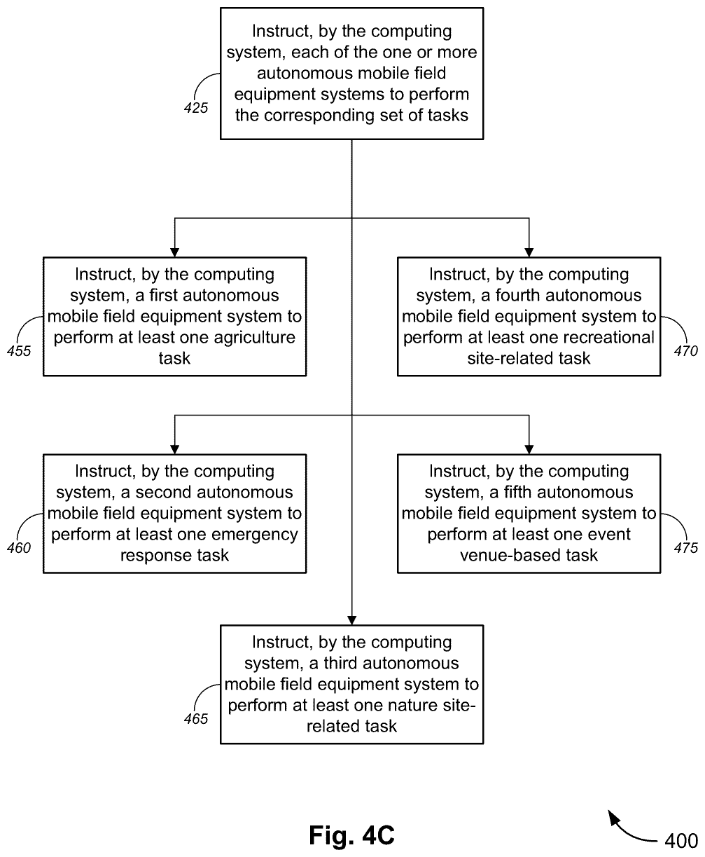

In operation, at least one of system orchestrator(s) 105a-105n and/or 105R or field equipment computing system 125a (collectively, “computing system”) may perform methods for implementing mobile integrated field-deployed task-based equipment automation system, as described in detail with respect to FIG. 4. An example equipment transport system is described in detail with respect to FIG. 2A, while an example autonomous mobile field equipment system is described in detail with respect to FIG. 2B, and an example set of use cases is described in detail with respect to FIG. 3. In some embodiments, the computing system may further include at least one of a server, a cloud computing system, or a distributed computing system, and/or the like.

These and other functions of the system 100 (and its components) are described in greater detail below with respect to FIGS. 2-4.

FIGS. 2A and 2B (collectively, “FIG. 2”) depict various example systems 200A and 200B and corresponding components for implementing mobile integrated field-deployed task-based equipment automation system, in accordance with various embodiments. FIG. 2A depicts a non-limiting example system 200A illustrating equipment transport system 215, its components, and autonomous mobile field equipment systems 220 and associated components, in accordance with various embodiments. FIG. 2B depicts a non-limiting example system 200B illustrating autonomous mobile field equipment system 220 and its components, in accordance with various embodiments. In some embodiments, system orchestrator 205 and corresponding database(s) 210, equipment transport system 215, autonomous mobile field equipment systems 220a-220z, autonomous mobile field equipment system components 225a-225i, docking stations 230a-230d, power sources 235a-235c and 235′, and transport sensor(s) 240 of FIGS. 2A and 2B may be similar, if not identical, to the system orchestrators 105a-105n or 105R and corresponding database(s) 110a-110n or 110R, equipment transport system 115, autonomous mobile field equipment systems 120a-120x, autonomous mobile field equipment system components 125a-125g, docking station(s) 130, power sources 135a-135n, and IoT-capable sensors 140a-140y and 140a′-140y′, respectively, of system 100 of FIG. 1, and the description of these components of system 100 of FIG. 1 are similarly applicable to the corresponding components of FIG. FIGS. 2A and 2B.

With reference to FIG. 2A, example system 200A includes at least one of system orchestrator 205 and corresponding database(s) 210, equipment transport system 215, a plurality of autonomous mobile field equipment systems 220a-220z (collectively, “autonomous mobile field equipment systems 220”), one or more docking stations 230a-230d (collectively, “docking stations 230”), one or more deployable power sources 235a-235c (collectively, “power sources 235” or “deployable power sources 235”), or onsite power source(s) 235′, and/or the like. Herein, n, x, y, y′, and z are non-negative integer numbers that may be either all the same as each other, all different from each other, or some combination of same and different (e.g., one set of two or more having the same values with the others having different values, a plurality of sets of two or more having the same value with the others having different values, etc.). In some embodiments, the system orchestrator 205 and corresponding database(s) 210 may be disposed or mounted on or within equipment transport system 215 (such as shown in FIG. 2A). Alternatively, the system orchestrator 205 and corresponding database(s) 210 may be disposed at one of the deployment locations (similar to system orchestrators 105a-105n of FIG. 1), or disposed at a remote location accessible via a network (similar to system orchestrator 105R that is accessible via network(s) 155 and telecommunications relay system(s) 160, as shown in FIG. 1). In an example, the equipment transport system 215 may include at least one of transport computing system 265, transport propulsion system 270, transport power supply 235″, one or more transport sensors 240, loading section 275a, loading door 275b, or actuator exchange system 280, and/or the like.

The system orchestrator 205 is configured to deploy, control, and coordinate each of the one or more autonomous mobile field equipment systems 220 to perform the tasks within a deployment location. In some examples, the system orchestrator 205 is further configured to deploy, control, and coordinate the equipment transport system 215 to transport the autonomous mobile field equipment systems 220, the docking stations 230, and the deployable power sources 235. In some cases, the system orchestrator 205 is further configured to deploy, control, and coordinate the docking stations 230 and/or the deployable power sources to provide a source of power to each of at least one autonomous mobile field equipment system 220 while said autonomous mobile field equipment system 220 is deployed within a deployment location (i.e., while said autonomous mobile field equipment system 220 is external to, and no longer loaded on, the equipment transport system 215). In some instances, the system orchestrator 205 is further configured to serve as a communications hub among the system components (e.g., equipment transport system 215, autonomous mobile field equipment systems 220, docking stations 230, deployable power sources 235a-235c, etc.) as well as being a communications relay or interface for deployment location components (e.g., IoT-capable sensors, local system orchestrators, etc.) and/or for one or more user devices (e.g., user devices 145 of FIG. 1, or the like).

The database(s) 210 is configured to store at least one of preset locations or coordinates, deployment patterns for the equipment transport system 215, deployment patterns for the autonomous mobile field equipment systems 220, deployment patterns for the docking stations 230, deployment patterns for the deployable power sources 235a-235c, status or update data from the equipment transport system 215, status or update data from each of at least one of the autonomous mobile field equipment systems 220, status or update data from each of at least one of the docking stations 230, status or update data from each of at least one of the deployable power sources 235a-235c, current and historical location data for the equipment transport system 215, current and historical location data for each of at least one of the autonomous mobile field equipment systems 220, current and historical location data for each of at least one of the docking stations 230, current and historical location data for each of at least one of the deployable power sources 235a-235c, sensor data from each of the transport sensor(s) 240, sensor data from at least one IoT-capable sensor (e.g., IoT-capable sensors 140a-140y and/or 140a′-140y′), sensor data from sensors of each of at least one of the autonomous mobile field equipment systems 220, or identifiers (“IDs”) and/or communications channels for system components (e.g., equipment transport system 215, autonomous mobile field equipment systems 220, docking stations 230, deployable power sources 235a-235c, etc.), and/or the like.

The transport computing system 265 is configured to control and/or communicatively couple with at least one of transport propulsion system 270, transport power supply 235″, one or more transport sensors 240, loading section 275a, loading door 275b, or actuator exchange system 280, and/or the like. The transport propulsion system 270 is configured to propel the equipment transport system, particularly when loaded with the autonomous mobile field equipment systems 220, the docking stations 230, and the deployable power sources 235, from or to a base location and/or from or to a deployment location among a plurality of deployment location (e.g., deployment locations 150a-150n of FIG. 1, or the like). In an example, the transport propulsion system 270 is configured to traverse over land (e.g., on roadways, through open terrain, via rail, etc.) between land-based locations (e.g., base location and/or deployment location(s)) or between locations on bodies of water (e.g., ponds, streams, rivers, canals, marshes, lakes, reservoirs, bays, seas, oceans, etc.). In another example, the transport propulsion system 270 is configured to traverse over bodies of water (e.g., ponds, streams, rivers, canals, marshes, lakes, reservoirs, bays, seas, oceans, etc.) between land-based locations (e.g., base location and/or deployment location(s) that are near the bodies of water) or between locations on said bodies of water (e.g., floating or submersible locations or platforms, etc.). In yet another example, the transport propulsion system 270 is configured to traverse through the air between locations (whether land-based, water-based, or space-based).

The transport power supply 235″ is configured to provide electrical power to at least one of the transport propulsion system 270, the deployable power sources 235a-235c, the docking stations 230a-230c (in some cases, via the deployable power sources 235a-235c), or one or more autonomous mobile field equipment systems among the plurality of autonomous mobile field equipment systems 220a-220z (in some cases, via the deployable power sources 235a-235c and/or the docking stations 230a-230c), the loading door 275b, or the actuator exchange system 280, and/or the like. The transport power supply 235″ may include at least one of a solar array, an electrical motor, a gas-powered motor, a chemical-powered motor, an electrical connection to a local power grid, or other power supply. The onsite power source(s) 235′ and the deployable power sources 235a-235c are each configured to provide electrical power to one or more autonomous mobile field equipment systems 220 (in some cases, via docking station(s) 230a-230d). In examples, the onsite power source(s) 235′ and the deployable power sources 235a-235c are configured to electrically couple with another power source (e.g., transport power supply 235″, an onsite solar array or solar panel-based power source, a wind power-based power source, or an electrical connector to a local power grid).

In some examples, the one or more transport sensors 240 are configured provide sensor data for assisting the propulsion of the equipment transport system 215 from one location to another. In examples, the one or more transport sensors 240 may each include at least one of one or more speedometers, one or more accelerometers, one or more geolocation sensors, one or more light sensors, one or more image sensors, one or more video sensors, one or more object detection sensors, one or more motion sensors, one or more infrared sensors, one or more lidar-based sensors, one or more radar-based sensors, one or more surface orientation sensors, one or more slope detection sensors, or power level sensors, and/or the like. The loading section 275a is configured to load, deploy, and receive the one or more autonomous mobile field equipment systems 220. The loading door 275b is configured to enable or close access to or from the loading section 275a and/or the equipment transport system 215. In some examples, the loading door 275b is configured serve as a ramp for loading, deploying, and receiving the one or more autonomous mobile field equipment systems 220. The actuator exchange system 280 is configured to replace a modular set of task-based actuators with another modular set of task-based actuators based on the set of tasks to be performed and based on the set of tasks that the modular sets of task-based actuators are capable of performing.

Referring to FIG. 2B, example system 200B may include an autonomous mobile field equipment system 220. The autonomous mobile field equipment system 220 may include at least one of computing system or field equipment computing system 225a, communications system or field equipment communications system 225b, one or more task-based actuators 225c, one or more sensors or field equipment sensors 225d, a propulsion system or field equipment propulsion system 225e, a power supply or field equipment power supply system 225f, one or more lights 225g, one or more displays and/or speakers 225h, or other field equipment components 225i, and/or the like.

The field equipment computing system 225a is configured to control and coordinate at least one of the field equipment propulsion system 225e or the one or more sets of task-based actuators 225c, based at least in part on sensor data collected by the one or more field equipment sensors 225d. In some examples, the field equipment computing system 225a is further configured to control and/or communicatively couple with at least one of the field equipment communications system 225b, the one or more field equipment sensors 225d, the one or more lights 225g, the one or more displays and/or speakers 225h, or the other field equipment components 225i, and/or the like.

The field equipment communications system 225b is configured to handle communications between the field equipment computing system 225a and a system orchestrator (e.g., system orchestrator 105a-105n, 105R, and/or 205). In some examples, the communications includes receiving instructions to perform tasks within the deployment location and sending status updates and sensor data. The one or more field equipment sensors 225d are configured to collect sensor data. In some examples, the one or more field equipment sensors 225d may include, or may further include, at least one of camera(s) 285a, lidar/radar/sonar-based system(s) 285b, or other sensor(s) 285c (collectively, “sensor(s) 285”). In some embodiments, the one or more field equipment sensors 225d are similar, if not identical, to sensors 125d of FIG. 1.

The field equipment propulsion system 225e is configured to propel said autonomous mobile field equipment system 220 throughout a deployment location. In examples, the field equipment propulsion system 225e includes at least one of a motor and motor control system 295a, brake and brake control system 295b, or air/ground/marine/space propulsion system 295c, and/or the like. In some examples, motor and motor control system 295a includes at least one of an electrical motor, a gas-powered motor, a chemical-powered motor, or other type of motor, and/or the like, and further includes a motor control system for controlling the motor. In examples, brake and brake control system 295b includes at least one of a disc-based brake system, an air brake system, a pneumatic brake system, or a fluid-based brake system, and/or the like, and further includes a brake control system for controlling the brake system. In some examples, the air/ground/marine/space propulsion system 295c includes at least one of a propeller/rotor/wing-based system 295d (e.g., for an air-based autonomous mobile field equipment system 220), a wheel/continuous track-based system 295e (e.g., for a ground-based autonomous mobile field equipment system 220), an impeller/water-jet/paddle/sail-based system 295f (e.g., for a water-based autonomous mobile field equipment system 220), or a rocket/thruster-based system 295g (e.g., for a space-based autonomous mobile field equipment system 220), and/or the like. The propeller/rotor/wing-based system 295d includes at least one of one or more air propellers, one or more helicopter rotors, one or more drone rotors, one or more sets of aeronautical wings, or an airframe, and/or the like. The wheel/continuous track-based system 295e includes at least one of a set of tires, a set of continuous tracks and corresponding track-based system, two or more axles, or a chassis, and/or the like. The impeller/water-jet/paddle/sail-based system 295f includes at least one of an impeller-based system, a water-jet-based system, a paddle-based system, a sail-based system, or a hull, and/or the like. The rocket/thruster-based system 295g includes at least one of a rocket-based propulsion system, a thruster-based system, or a spacecraft frame, and/or the like.

The field equipment power supply system 225f is configured to supply power to at least one of the field equipment propulsion system 225e, the one or more sets of task-based actuators 225c, the one or more field equipment sensors 225d, the field equipment computing system 225a, or the field equipment communications system 225b, and/or the like. The lights 225g is used to illuminate an area in front of, around, above, and/or below said autonomous mobile field equipment system 220. The lights 225g may also be configured as indicator lights for providing information to a user regarding the autonomous mobile field equipment system 220 or its components, regarding other autonomous mobile field equipment systems 220, and/or regarding the equipment transport system 215, or the like. The display devices of display(s)/speaker(s) 225h may each include at least one of a light emitting diode (“LED”) display device, a liquid crystal display (“LCD”) device, a touchscreen display device, a non-touchscreen display device, or an array of display bulbs, and/or the like. The speaker devices of display(s)/speaker(s) 225h may each include at least one of an electrostatic loudspeaker-base device, a bass speaker (or subwoofer), a tweeter, a squawker (or mid-bass or mid-range driver), a wireless speaker, or a wired speaker, and/or the like. The other components 225i may include, e.g., one or more power converters configured to transduce or convert one form of power to another (e.g., electrical power to mechanical power), one or more tow systems configured to tow objects (e.g., other autonomous mobile field equipment systems, objects in the deployment location, etc.), daisy-chaining power system configured to connect two or more autonomous mobile field equipment systems in series when one autonomous mobile field equipment system is connected to a power source, or other accessory components.

The one or more sets of task-based actuators 225c are each configured to perform a set of tasks. According to some embodiments, the set of tasks each includes at least one of an agriculture task, an emergency response task, a nature conservation task, a nature reclamation task, a nature maintenance task, a recreational area plant task, a recreational area plant watering task, a recreational area plant fertilizing task, a recreational area plant removal task, an object relocation task, a site cleanup task, or a waste removal task, and/or the like. In examples, the one or more sets of task-based actuators 225c may include at least one of one or more lifting and/or placement actuators 290a, one or more planting and/or harvesting actuators 290b, one or more watering and/or fertilizing actuators 290c, one or more digging and/or construction actuators 290d, one or more cleanup and/or removal actuators 290e, or other actuators 290f, and/or the like.

In some examples, a set of agriculture tasks includes at least one of preparing for planting, planting, watering, fertilizing, harvesting, or removing one or more of a plurality of seeds or a plurality of plants, and/or the like. In examples, field equipment computing system 225a and/or system orchestrator may instruct the propulsion system 225e and/or the one or more sets of task-based actuators 225c to perform at least one agriculture task among the set of agriculture tasks. In an example, the field equipment computing system 225a and/or the system orchestrator sends at least one of one or more first instructions to prepare a first planting area within the first deployment location for planting; one or more second instructions to plant the one or more of the plurality of seeds or the plurality of plants in the first planting area within the first deployment location; one or more third instructions to water plants within the first planting area; one or more fourth instructions to fertilize plants within the first planting area; one or more fifth instructions to harvest plants within the first planting area; or one or more sixth instructions to remove dead, dying, or undesired plants from the first planting area; and/or the like.

The one or more first instructions include instructions—e.g., to the propulsion system 225e, the lifting or placement actuator(s) 290a, and/or the digging/construction actuator(s) 290d—for moving a plurality of planting media to the first planting area; and for preparing each of the plurality of planting media for planting. The one or more second instructions include instructions—e.g., to the propulsion system 225e, the planting or harvesting actuator(s) 290b, and/or the digging/construction actuator(s) 290d—for moving the one or more of the plurality of seeds or the plurality of plants to the first planting area; creating a space within each corresponding portion of the plurality of planting media; inserting the one or more of the plurality of seeds or the plurality of plants in corresponding created spaces of the plurality of planting media; and covering gaps within the created spaces around the inserted one or more of the plurality of seeds or the plurality of plants. The one or more third instructions include instructions—e.g., to the propulsion system 225e and/or the watering or fertilizing actuator(s) 290c—for moving to the first planting area with a load of water; and dispensing water to the one or more of the plurality of seeds or the plurality of plants that have been planted in the corresponding plurality of planting media.

The one or more fourth instructions include instructions—e.g., to the propulsion system 225e and/or the watering or fertilizing actuator(s) 290c—for moving to the first planting area with a load of fertilizer; and dispensing fertilizer to the one or more of the plurality of seeds or the plurality of plants that have been planted in the corresponding plurality of planting media. The one or more fifth instructions include instructions—e.g., to the propulsion system 225e, the planting or harvesting actuator(s) 290b, and/or the lifting or placement actuator(s) 290a—for moving to the first planting area; harvesting harvestable portions of the one or more of the plurality of seeds or the plurality of plants based on a determination that the harvestable portions are ready for harvesting; and moving the harvested harvestable portions to a harvest collection location for loading and transport from the first deployment location. The one or more sixth instructions include instructions—e.g., to the propulsion system 225e, the sensor(s) 225d, and/or the lifting or placement actuator(s) 290a—for moving to the first planting area; identifying plants for removal from the first planting area; moving to and extracting plants that have been identified for removal; and moving the harvested harvestable portions to a harvest collection location for loading and transport from the first deployment location.

In some examples, the one or more of the plurality of seeds or the plurality of plants are planted in a plurality of straw bales, each straw bale being bundled together to form an integrated structure. An outer surface of the integrated structure forms a container while a middle portion of the integrated structure decomposes to form the plurality of planting media. In an example, the lifting or placement actuators 290a include a set of fork-lift actuators and/or a set of straw bale transport and placement actuator arms. Each fork-lift actuator is configured to lift agricultural objects as the autonomous mobile field equipment system is moved from one position to another within the deployment location. The set of straw bale transport and placement actuator arms each configured to carry one or more straw bales that are used for planting the one or more of the plurality of seeds or the plurality of plants as the autonomous mobile field equipment system is moved to a planting area within the deployment location, and to place and orient the one or more straw bales in designated positions and orientations within the planting area. In examples, the planting or harvesting actuators 290b include at least one of a set of seed planting actuator arms or a set of sapling planting actuator arms, and/or the like. The set of seed planting actuator arms is configured to create space within a portion of a planting medium of a straw bale, to insert one or more seeds that are loaded from an attached seed hopper into the created space, and to cover gaps within the created spaces around the inserted one or more seeds. In some cases, the set of seed planting actuator arms includes a seeder attachment, a seed drill attachment, or a seeding machine attachment that is configured to position seeds in the planting media and to bury the seeds to a predetermined depth based on the particular type of seed. The set of sapling planting actuator arms is configured to create space within a portion of a planting medium of a straw bale, to retrieve a sapling from a loader attachment on the first autonomous mobile field equipment system, to insert the retrieved sapling into the created space, and to cover gaps within the created spaces around the inserted sapling. In some instances, the set of sapling planting actuator arms includes a tree spade-like attachment, a tree planter-like attachment, or a tree transplanter-like attachment that is configured to autonomously plant trees, saplings, and other plants in the planting media.

In some examples, the watering or fertilizing actuators 290c include a set of water dispensing actuator arms and/or a set of fertilizer dispensing actuator arms. The set of water dispensing actuator arms is configured to dispense a determined amount of water to each of the one or more of the plurality of seeds or the plurality of plants that have been planted in the corresponding plurality of planting media, the water being extracted from a water container attachment on the first autonomous mobile field equipment system. The set of fertilizer dispensing actuator arms is configured to dispense a determined amount of fertilizer to each of the one or more of the plurality of seeds or the plurality of plants that have been planted in the corresponding plurality of planting media, the fertilizer being extracted from a fertilizer container attachment on the first autonomous mobile field equipment system. In examples, the planting or harvesting actuators 290b further include a set of fruit harvesting actuator arms and/or a set of crop harvesting actuator arms. The set of fruit harvesting actuator arms is configured to identify which fruit growing in the planting area is harvestable, to harvest (e.g., using automated clamping actuators to gently pluck, rip, and/or twist off and/or using automated shears or cutters to cut off) one or more fruits that are identified as being harvestable, and to load the harvested one or more fruits onto a load carrier attachment on the first autonomous mobile field equipment system. The set of crop harvesting actuator arms each configured to identify (e.g., using sensors and the computing system or other software) which crops growing in the planting area are harvestable, to harvest one or more crops that are identified as being harvestable (in a manner similar to harvesting fruits, or in some cases, using a scything tool or the like), and to load the harvested one or more crops onto the load carrier attachment on the first autonomous mobile field equipment system.

In examples, the digging or construction actuators 290d and/or the cleanup or removal actuators 290e include a set of plant removal actuator arms. The set of plant removal actuator arms is configured to identify (e.g., using sensors and the computing system or other software) plants for removal from the planting area, to extract one or more plants that are identified for removal, by performing at least one of pulling, twisting, digging, or cutting the one or more plants from a corresponding planting medium, and to load the harvested one or more crops onto the load carrier attachment on the first autonomous mobile field equipment system.

Although the system is described above with respect to use within an agricultural use case, the various embodiments are not so limited, and the system may be used in various other use cases. In examples, a set of emergency response tasks includes at least one of locating trapped people or pets, identifying pathways toward the trapped people or pets, identifying safe ways to extract or evacuate the trapped people or pets, digging or moving obstructing objects, or leading or carrying the trapped people or pets to safety, and/or the like. In such examples, other actuators 290f may include actuator arms having sensors (e.g., cameras, IR sensors, etc.) and/or lights, prying attachments, gripping attachments, towing attachments, grappling attachments, and/or the like for performing one or more of the set of emergency response tasks.

In some examples, a set of nature conservation tasks includes at least one of conserving a habitat, preventing deforestation, or maintaining soil organic matter, and/or the like. In examples, a set of nature reclamation tasks includes at least one of re-contouring a land surface, forming one or more drainage ditches, replacing soil (e.g., subsoil, topsoil, etc.), performing revegetation, seeding or reseeding, or monitoring soil and/or water quality and vegetation establishment, and/or the like. In some examples, a set of nature maintenance tasks includes at least one of performing soil management tasks, sowing, planting, mowing, pruning, replacement, or removal, and/or the like. In examples, a set of recreational area plant tasks includes at least one of planting, weeding, watering, fertilizing, pruning, or removal, and/or the like. These examples may be similar to, and may utilize similar attachments and actuators as those for the agricultural tasks described above.

In examples, a set of object relocation tasks includes at least one of moving objects from one location to another. Such tasks may utilize the lifting or placement actuators 290a as described above in conjunction with the propulsion system 225e. In some examples, a set of site cleanup tasks includes at least one of cleaning waste accumulation in an area, removing pollutants (e.g., oil, chemicals, etc.) from the area, washing surfaces in the area, and/or sanitizing an area. Such tasks may utilize attachments similar to those for the watering or fertilizing actuators to apply cleanup materials (including absorbent materials, chemicals, or other materials and/or to spray surfactants, etc.) to cover the pollutants or waste products, with cleanup or removal actuators 290e including spade attachments, shovel attachments, brush attachments, scoop attachments, or vacuum attachments and/or the like, to remove the collection of cleanup materials that have absorbed or attached to the covered pollutants or waste products. The cleanup or removal actuators 290e may further include a water sprayer attachment and/or a sanitizing fluid sprayer attachment to spray the affected area to clean and/or sanitize it. In examples, a set of waste removal task includes at least one of sifting, sorting, lifting, and transporting waste products. In such cases, the cleanup or removal actuators 290e may further include sifting attachments and/or sorting attachments, that perform these tasks in conjunction with the lifting or placement actuators 290a and propulsion system 225e. In some examples, cleanup of oil spills in the ocean may be performed using water-based and/or amphibious autonomous mobile field equipment systems deployed from water-based equipment transport systems (if off-shore) or from land-based equipment transport systems (if near or spilling onto land). In examples, orbital debris (from obsolete or damaged satellites and spacecraft or the like) may be cleaned up using space-based autonomous mobile field equipment systems deployed from space-based equipment transport systems (that are either launched from earth or deployed from orbiting stations). In some cases, satellites and/or spacecraft may be repositioned along different orbital paths and/or repaired using space-based autonomous mobile field equipment systems.

In examples, the set of tasks is performed using one or more modular and interchangeable sets of task-based actuators. In such examples, the computing system 225a and/or the system orchestrator determines whether a second autonomous mobile field equipment system is currently equipped with a set of task-based actuators that is capable of performing a currently assigned set of tasks. Based on a determination that a currently equipped set of task-based actuators is not capable of performing the currently assigned set of tasks, the computing system 225a and/or the system orchestrator instructs an actuator exchange system (e.g., actuator exchange system 280 of FIG. 2A) to replace the currently equipped set of task-based actuators with a set of task-based actuators that is capable of performing the currently assigned set of tasks.

These and other functions of the examples 200A and 200B (and their components) are described in greater detail herein with respect to FIGS. 1, 3, and 4.

FIG. 3 depicts a schematic diagram illustrating a non-limiting example 300 of a geographic area in which mobile integrated field-deployed task-based equipment automation system may be implemented, in accordance with various embodiments. In some embodiments, deployment locations 305a-305c, system orchestrator 325, equipment transport systems 315a and 315b, autonomous mobile field equipment systems 320a and 320b, docking station(s) 330, power source(s) 335, and sensor(s)/drone(s) 355 and 360 of FIGS. 2A and 2B may be similar, if not identical, to the deployment locations 150a-150n, system orchestrators 105a-105n or 105R, equipment transport system 115, autonomous mobile field equipment systems 120a-120x, docking station(s) 130, power sources 135a-135n, and IoT-capable sensors 140a-140y and 140a′-140y′, respectively, of system 100 of FIG. 1, and the description of these components of system 100 of FIG. 1 are similarly applicable to the corresponding components of FIG. FIGS. 2A and 2B.

As described above, equipment transport systems and autonomous mobile field equipment systems may be deployed to deployment locations. In general, the deployment locations may each include one of an agricultural site, an emergency site, a nature site, a recreational site, or an event venue, and/or the like. In some instances, the agricultural site includes at least one of an agricultural field, a farm, a plot of land, a ranch, an orchard, a crop field, or a sod field, and/or the like. In some cases, the emergency site includes one of a site of a natural disaster, an accident site, a hazardous waste spill site, or a search and rescue site, and/or the like. In examples, the nature site includes one of a forest, a field, a meadow, an aquatic site, or an orbital site, and/or the like. In some cases, the recreational site includes one of a park, a plant garden, a flower garden, a plant nursery, a botanical garden, a residential lawn, a commercial lawn, a residential garden, a commercial garden, a greenway, or a recreational center, and/or the like. In some instances, the event venue includes one of a stadium, a concert hall, an arena, or a festival site, and/or the like.

With reference to FIG. 3, example geographic location or region 300 (or “geographic area 300” or the like) may include, without limitation, one or more deployment locations 305a-305c (collectively, “deployment locations 305”) that may be classified as agricultural sites and/or nature sites. In particular, as shown in the non-limiting example 300, deployment location 305a is one of a farm or a crop field, while deployment location 305b is or includes an aquatic site (e.g., a pond or a lake, etc.), and deployment location 305c is a farm or an orchard. These example deployment locations are depicted merely for purposes of illustration, and the equipment transport system and the autonomous mobile field equipment systems may be deployed to any of the other deployment locations as described above, based on the types of propulsion systems that the equipment transport system and autonomous mobile field equipment systems have (as described in detail above with respect to FIGS. 2A and 2B), in some cases, with modular task-based actuators that may be exchanged with other modular task-based actuators to perform particular tasks at those deployment locations.

Turning back to FIG. 3, in cases in which the equipment transport system 315 is a land-based vehicle, the one or more deployment locations 305a-305c may be accessible via roadways or vehicular paths, including main roadways or vehicular paths 310, access roadways or vehicular paths 310a-310d, and/or the like. In examples, equipment transport system 315 may travel along the roadways or vehicular paths to transport a plurality of autonomous mobile field equipment systems 320 to the deployment locations 305. In an example, land-based equipment transport system 315a may transport and deploy land-based autonomous mobile field equipment systems 320a on ground-based or land-based deployment locations (such as farm or crop field 305a, or farm or orchard 305c. In another example, land-based equipment transport system 315b may transport and deploy water-based autonomous mobile field equipment systems 320b on water-based deployment locations (e.g., pond or lake 350c). In some cases, the water-based deployment locations may further include other standing surface water sources 350a (e.g., lakes, ponds, wetlands, reservoirs, swamps, seas, bays, oceans, etc.) and/or moving surface water sources 350b (i.e., waterways or watercourses; e.g., rivers, streams, creeks, brooks, rivulets, gullies, rills, aqueducts, or canals, and/or the like). In some cases, the geographical areas 300 may include, but are not limited to, houses, barns, or other structures, and/or the like, such as shown between access roadway 310c and deployment location 305a.

The land-based equipment transport systems 315a and 315b may include respective loading sections and loading doors (e.g., loading section 275a and loading door 275b of FIG. 2A) that are configured for loading, deploying, and receiving land-based and water-based autonomous mobile field equipment systems, respectively. In some examples, the loading sections and loading doors may include roller-based, wheel-based, and/or ramp-based portions that may be used to interface with (a bottom portion of) and/or convey the autonomous mobile field equipment systems onto or off the loading sections and loading doors. The equipment transport systems 315a and 315b may also load, deploy, and receive docking stations 330. The docking stations 330 may each include its own propulsion system, in which case they may traverse to an area within the deployment location at which an onsite power source (e.g. a wind-power-based power source, a geothermal-based power source, an electrical grid-based power source, and/or a solar array-based power source 335, or the like; similar to onsite power source(s) 235′ of FIG. 2A) is located. Alternative or additional to the onsite power source, deployable power sources (e.g., deployable power sources 235a-235c of FIG. 2A) may be used. In some examples, at least one autonomous mobile field equipment system 320 is used to move at least one of one or more field equipment docking stations or one or more deployable power sources between the equipment transport system and at least one docking position within the deployment location. In such cases, the at least one autonomous mobile field equipment system 320 that has been equipped with a lifting actuator (or the like) may be used to carry or transport the docking station(s) 330 to the onsite power source and/or to carry or transport the docking station(s) 330 and/or deployable power source(s) to the docking position within the deployment location. In the cases that the docking station(s) 330 and/or deployable power source(s) is carried or transported by the at least one autonomous mobile field equipment system 320, neither the docking station(s) 330 and/or the deployable power source(s) need include a propulsion system. Even if at least one of each field equipment docking station or each deployable power source includes a propulsion system, such apparatuses may still be moved within the deployment location by the at least one autonomous mobile field equipment system.

In some examples, the equipment transport system 315 may also serve as an alternate power source for recharging the autonomous mobile field equipment systems 320. In examples, the equipment transport system further includes one or more solar panels on a roof portion, at least one power storage device, and one or more internal power supply ports that are electrically coupled to the at least one power storage device and that are disposed at, on, or near the loading section. In an example, at least one power connector of each field equipment docking station is further configured to electrically couple with one of the one or more internal power supply ports. While loaded, the one or more autonomous mobile field equipment systems are docked with corresponding one or more field equipment docking stations that are coupled with corresponding one or more internal power supply ports.

In some embodiments, sensor platforms and/or IoT-capable sensors 355 may be disposed at one or more areas within, throughout, and/or around a deployment location (such as IoT-capable sensors 355 around deployment location 305a in FIG. 3. In examples, sensor platforms and/or IoT-capable sensors 355 may include, without limitation, at least one of one or more humidity sensors, one or more soil moisture sensors, one or more ground water sensors, one or more water flow sensors, one or more clog sensors, one or more water pump sensors, one or more irrigation system sensors, one or more temperature sensors, one or more wind sensors, one or more weather sensors, one or more slope sensors, one or more topography sensors, one or more light sensors, one or more light intensity sensors, one or more image sensors, one or more video sensors, one or more object orientation sensors, one or more surface orientation sensors, one or more plant monitoring sensors, one or more motion sensors, one or more infrared sensors, or one or more pest detectors, and/or the like. The sensor platforms and/or IoT-capable sensors 355 may send sensor data, via said wireless communications (depicted in FIG. 3 by lightning bolt symbols), to the system orchestrator(s) 325 that may be disposed or mounted on at least one equipment transport system 315 or that may be located remotely and accessible via a network(s) and communications relays systems (e.g., remote system orchestrator 105R that is accessible via network(s) 155 via telecommunications relay system(s) 160 of FIG. 1, or the like). Sensor data collected by field equipment sensors (e.g., sensors 125d, transport sensors 240, and/or sensors 225d and 285a-285c, and/or the like) may also be sent in a similar manner to system orchestrator(s) 325. According to some embodiments, a drone 360 may travel within the geographic area 305. In some cases, the drone 360 may travel along one or more paths through the geographic area 305. In some embodiments, the drone 360 may include, without limitation, one of an aerial drone (as depicted in FIG. 3), a land-based drone (not shown), a water-based drone (not shown), or an autonomous vehicle (not shown), and/or the like. Sensor data collected by the drone 360 may similarly be sent to the system orchestrator(s) 325.

System orchestrator(s) 325 is configured to deploy, control, and coordinate deployable systems, in some cases, based on or using the collected sensor data from the various sensors (including the IoT-capable sensors 355, the field equipment sensors, and/or the drone sensors, and/or the like). The deployable systems include at least one of each of the equipment transport systems 315a and/or 315b to transport autonomous mobile field equipment systems (as well as docking stations and/or deployable power sources) to deployment locations, each of the one or more autonomous mobile field equipment systems 320a and/or 320b to perform the tasks within the deployment location, and/or drones (e.g., drone 360) to provide sensor data within, throughout, or around the deployment location, and/or the like. In some embodiments, in the case that IoT-based microwells are present at the deployment location, sensor data from sensor platforms of the microwells may likewise be sent to the system orchestrator(s) 325, and such sensor data may similarly be used by the system orchestrator(s) 325 to deploy, control, and coordinate the deployable systems. In some examples, the system orchestrator(s) 325 may also be used to control the IoT-based microwells to perform their functions. The IoT-based microwells as described in greater detail in U.S. patent application Ser. No. 17/735,761 (the “'761 Application”), filed May 3, 2022, by William Benassi (attorney docket no. 1635-US-U1), entitled, “Internet of Things (“IoT”)-Based Microwell Solution for Irrigation,” which claims priority to U.S. Patent Application Ser. No. 63/217,848 (the “'848 Application”), filed Jul. 2, 2021, by William Benassi (attorney docket no. 1635-US-P1), the disclosure of each of which is incorporated herein by reference in its entirety for all purposes.

In the non-limiting example of FIG. 3, system orchestrator(s) 325 deploys, controls, and coordinates autonomous mobile field equipment systems 320a within deployment location 305a (in this case, farm or crop field 305a) to prepare for planting, to plant, to water, to fertilize, to harvest, and/or to remove seeds and/or plants 340a and 340b. In some cases, the seeds and/or plants are planted within planting media 345a and/or 345b, which may include straw bale (as described above), ground soil, potted soil, planter soil, hydroponics containers, or other planning media. Some autonomous mobile field equipment systems may be configured (or may be equipped with modular task-based actuators that are configured) to perform a first particular task (e.g., one of preparing for planting, planting, watering, fertilizing, harvesting, or removing seeds or plants), while other autonomous mobile field equipment systems may be configured (or may be equipped with modular task-based actuators that are configured) to perform a second particular task that is different from the first particular task (e.g., another one of preparing for planting, planting, watering, fertilizing, harvesting, or removing seeds or plants). These autonomous mobile field equipment systems may be deployed in tandem, in series, or in parallel to perform the overall set of agricultural tasks.

In an example, a first autonomous mobile field equipment system transports a number of straw bales (e.g., in a sled or trailer, or the like) to a planting area within the deployment location, while one or more second autonomous mobile field equipment systems each unloads, positions, and arranges the straw bales based on a planting pattern within the planting area. After the straw bales are ready for planting, in some cases, based on a third autonomous mobile field equipment system that is deployed to monitor the condition of the straw bales for planting, one or more fourth autonomous mobile field equipment systems plants seeds and/or plants (e.g., saplings) in the straw bales, while one or more fifth autonomous mobile field equipment systems waters the planted seeds and/or plants, and one or more sixth autonomous mobile field equipment systems fertilizes the planted seeds and/or plants. After the crops are ready for harvesting, in some cases, based on a seventh autonomous mobile field equipment system that is deployed to monitor the condition of the crops growing from the planted seeds and/or plants, one or more eighth autonomous mobile field equipment systems harvests the crops (e.g., fruits, edible crops, etc.), in some cases, loading the harvested crops onto a container that is either pulled on a trailer by each of the one or more eighth autonomous mobile field equipment systems or by each of one or more ninth autonomous mobile field equipment systems that are deployed together with the one or more eighth autonomous mobile field equipment systems. After harvesting, one or more tenth autonomous mobile field equipment systems may be deployed to remove the remaining plants or crops and/or to remove no-longer-usable straw bales.

In another example, autonomous mobile field equipment systems 320a may be deployed to harvest fruits from trees 340d in an orchard (e.g., deployment location 305c), in a similar manner as harvesting of crops in deployment location 305a. In yet another example, water-based autonomous mobile field equipment systems 320b may be deployed within a pond or lake 350c (e.g., in deployment location 305b), e.g., to maintain the aquatic site (in some cases, to remove unwanted vegetation 340c, to condition the water to remove algae or other growths, etc.).

In some aspects, one or more equipment transport systems loaded with autonomous mobile field equipment systems may themselves be loaded onto either a flatbed trailer or enclosed trailer that is pulled by a semi-tractor or other vehicle that is either human-driven or autonomously driven. In some examples, each equipment transport system may be a modified semi-tractor and trailer combination. In some cases, each equipment transport system may be a modified trailer or a container on a flatbed trailer that is transported to a deployment location by a semi-tractor and left at that location until the tasks have been completed. The semi-tractor is used to transport one or more of these trailer-based or container-based equipment transport systems from/to the base location and to/from one deployment location to another. Within a region, a semi-tractor may transport multiple such equipment transport systems within each day, and can collect them near the end of the day or when the tasks have been completed at the locations. The tasks may be performed by the equipment transport systems and the autonomous mobile field equipment systems at the deployment locations in an autonomous manner, controlled, managed, and coordinated by the system orchestrator(s). The system orchestrator(s) can communicate with drivers of the semi-tractors and/or farmers or other users via messages and/or UI displays on user devices (e.g., user devices 145 of FIG. 1, or the like).

These and other functions of the example(s) 300 (and its components) are described in greater detail herein with respect to FIGS. 1, 2, and 4.

FIGS. 4A-4C (collectively, “FIG. 4”) depicts flow diagrams illustrating a method 400 for implementing mobile integrated field-deployed task-based equipment automation system, in accordance with various embodiments. Method 400 of FIG. 4A continues onto FIG. 4B following the circular marker denoted, “A.”

While the techniques and procedures are depicted and/or described in a certain order for purposes of illustration, it should be appreciated that certain procedures may be reordered and/or omitted within the scope of various embodiments. Moreover, while the method 400 illustrated by FIG. 4 can be implemented by or with (and, in some cases, are described below with respect to) the systems, examples, or embodiments 100, 200A, 200B, and 300 of FIGS. 1, 2A, 2B, and 3, respectively (or components thereof), such methods may also be implemented using any suitable hardware (or software) implementation. Similarly, while each of the systems, examples, or embodiments 100, 200A, 200B, and 300 of FIGS. 1, 2A, 2B, and 3, respectively (or components thereof), can operate according to the method 400 illustrated by FIG. 4 (e.g., by executing instructions embodied on a computer readable medium), the systems, examples, or embodiments 100, 200A, 200B, and 300 of FIGS. 1, 2A, 2B, and 3 can each also operate according to other modes of operation and/or perform other suitable procedures.

In the non-limiting embodiment of FIG. 4A, method 400, at operation 405, includes instructing, by a computing system, an equipment transport system to traverse to a first deployment location from its current location. Method 400 further includes, at operation 410, instructing, by the computing system, the equipment transport system to deploy, within the first deployment location, one or more autonomous mobile field equipment systems that are loaded within the equipment transport system, after the equipment transport system has arrived at the first deployment location. In some embodiments, the computing system includes at least one of a system orchestrator, a server, a cloud computing system, or a distributed computing system, and/or the like.

At operation 415, method 400 further includes determining, by the computing system, whether a first autonomous mobile field equipment system is currently equipped with a set of task-based actuators that is capable of performing a currently assigned set of tasks. If not, method 400 continues onto the process at operation 420. If so, method 400 continues onto the process at operation 425. In examples, the set of tasks is performed using one or more modular and interchangeable sets of task-based actuators. In some examples, the set of tasks each includes at least one of an agriculture task, an emergency response task, a nature conservation task, a nature reclamation task, a nature maintenance task, a recreational area plant task, a recreational area plant watering task, a recreational area plant fertilizing task, a recreational area plant removal task, an object relocation task, a site cleanup task, or a waste removal task, and/or the like.

At operation 420, method 400 includes, based on a determination that a currently equipped set of task-based actuators is not capable of performing the currently assigned set of tasks, instructing, by the computing system, an actuator exchange system to replace the currently equipped set of task-based actuators with a set of task-based actuators that is capable of performing the currently assigned set of tasks. Method 400 continues onto the process at operation 425. At operation 425, method 400 includes instructing, by the computing system, each of the one or more autonomous mobile field equipment systems to perform a corresponding set of tasks, after being deployed to one or more portions of the first deployment location.

Method 400 further include, at operation 430, sending, by the computing system, one or more messages to at least one user device. In examples, the one or more messages includes at least one of: a first message for sending after the equipment transport system arrives at the first deployment location, the first message indicating that the equipment transport system has arrived at the first deployment location; a second message for sending after the equipment transport system deploys the one or more autonomous mobile field equipment systems, the second message indicating that the one or more autonomous mobile field equipment systems have been deployed within the first deployment location; a third message for sending after the computing system assigns the corresponding set of tasks to one of the one or more autonomous mobile field equipment systems, the third message indicating that the one of the one or more autonomous mobile field equipment systems has been assigned the corresponding set of tasks; or a fourth message for sending after the computing system receives one or more task status updates from one of the one or more autonomous mobile field equipment systems, the fourth message including the one or more task status updates for the one of the one or more autonomous mobile field equipment systems; and/or the like.

At operation 435, method 400 further includes instructing, by the computing system, each of the one or more autonomous mobile field equipment systems to move to a field equipment docking station to dock with the field equipment docking station to recharge its field equipment power supply, based on a determination that its field equipment power supply is at a power level below a first predetermined threshold level. Method 400 may continue onto the process at operation 440 in FIG. 4B following the circular marker denoted, “A.”

At operation 440 in FIG. 4B (following the circular marker denoted, “A,” in FIG. 4A), method 400 includes instructing, by the computing system, each of the one or more autonomous mobile field equipment systems to return the equipment transport system for reloading, based on a determination that the set of tasks have been completed; instructing, by the computing system, the equipment transport system to receive and load each of the one or more autonomous mobile field equipment systems (at operation 445); and instructing, by the computing system, the equipment transport system to traverse from the first deployment location to one of a base location or a second deployment location (at operation 450).

With reference to FIG. 4C, instructing each of the one or more autonomous mobile field equipment systems to perform the corresponding set of tasks (at operation 425) includes at least one of instructing, by the computing system, a first autonomous mobile field equipment systems to perform at least one agricultural task (at operation 455); instructing, by the computing system, a second autonomous mobile field equipment systems to perform at least one emergency response task (at operation 460); instructing, by the computing system, a third autonomous mobile field equipment systems to perform at least one nature site-related task (at operation 465); instructing, by the computing system, a fourth autonomous mobile field equipment systems to perform at least one recreational site-related task (at operation 470); instructing, by the computing system, a fifth autonomous mobile field equipment systems to perform at least one event venue-based task (at operation 475); and/or the like.

### Exemplary System and Hardware Implementation

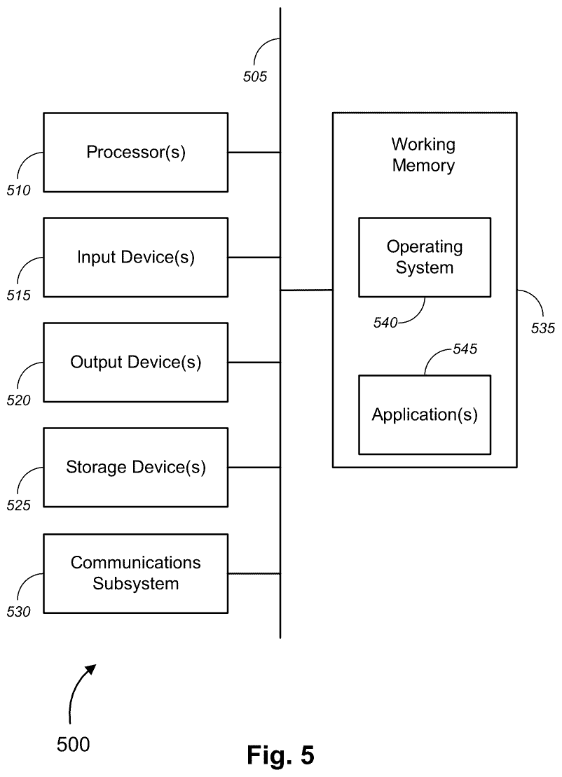

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., system orchestrators 105a-105n, 105R, 205, and/or 325, equipment transport systems 115, 215, 315a, and/or 315b, autonomous mobile field equipment systems 120a-120x, 220a-220z, 220, 320a, and 320b, docking stations 130, 230a-230d, and/or 330, power sources 135a-135n, 235a-235c, 235′, 235″, and/or 335, Internet of Things (“IoT”)-capable sensors 140a-140y, 140a′-140y′, 355, and/or 360, and/or user device(s) 145, transport computing system 265, actuator exchange system 280, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., system orchestrators 105a-105n, 105R, 205, and/or 325, equipment transport systems 115, 215, 315a, and/or 315b, autonomous mobile field equipment systems 120a-120x, 220a-220z, 220, 320a, and 320b, docking stations 130, 230a-230d, and/or 330, power sources 135a-135n, 235a-235c, 235′, 235″, and/or 335, IoT-capable sensors 140a-140y, 140a′-140y′, 355, and/or 360, and/or user device(s) 145, transport computing system 265, actuator exchange system 280, etc.), described above with respect to FIGS. 1-4—is shown including hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further include a working memory 535, which can include a RAM or ROM device, as described above.

The computer or hardware system 500 also may include software elements, shown as being currently located within the working memory 535, including an operating system 540, device drivers, executable libraries, and/or other code, such as one or more application programs 545, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that include the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A system, comprising:
one or more autonomous mobile field equipment systems, each comprising:
a field equipment propulsion system that is configured to propel said autonomous mobile field equipment system throughout a deployment location;
one or more sets of task-based actuators that are each configured to perform a set of tasks;
one or more field equipment sensors that are configured to collect sensor data;
a field equipment computing system that is configured to control and coordinate at least one of the field equipment propulsion system or the one or more sets of task-based actuators, based at least in part on sensor data collected by the one or more field equipment sensors;
a field equipment communications system that is configured to handle communications between the field equipment computing system and a system orchestrator, the communications including receiving instructions to perform tasks within the deployment location and sending status updates and sensor data; and
a field equipment power supply system that is configured to supply power to at least one of the field equipment propulsion system, the one or more sets of task-based actuators, the one or more field equipment sensors, the field equipment computing system, or the field equipment communications system; and
the system orchestrator that is configured to deploy, control, and coordinate each of the one or more autonomous mobile field equipment systems to perform the tasks within the deployment location.

2. The system of claim 1, further comprising:
an equipment transport system that is configured to transport the one or more autonomous mobile field equipment systems and to traverse from one deployment 3 location to another deployment location, the equipment transport system including a loading section that is configured to load, deploy, and receive the one or more autonomous mobile field equipment systems.

3. The system of claim 2, further comprising:
one or more field equipment docking stations, each configured to provide electrical power to one of the one or more autonomous mobile field equipment systems via connection with a power source, each field equipment docking station comprising:
at least one docking port each configured to electrically couple with one of the one or more autonomous mobile field equipment systems.

4. The system of claim 3, wherein the power source includes one of at least one onsite power source that is disposed within the deployment location, wherein each field equipment docking station further comprises:
at least one power connector each configured to electrically couple with the one of the at least one onsite power source that is disposed within the deployment location; and
a docking station propulsion system that is configured to propel the at least one docking station between the equipment transport system and the one of the at least one onsite power source.

5. The system of claim 4, wherein the at least one onsite power source comprises an array of solar panels that is permanently installed at the deployment location.

6. The system of claim 3, wherein the power source includes one of at least one deployable power source, each deployable power source comprising a solar powered generator that is configured to be deployed, by the equipment transport system, to at least one docking position within the deployment location, wherein each of the one or more field equipment docking stations is coupled with a corresponding one of the at least one deployable power source before or after being deployed to the at least one set position, wherein at least one of each field equipment docking station or each deployable power source comprises a propulsion system that is configured to propel the at least one of each field equipment docking station or each deployable power source between the equipment transport system and the at least one docking position within the deployment location.

7. The system of claim 2, wherein the system orchestrator is disposed within the equipment transport system, wherein the equipment transport system comprises a vehicle.

8. The system of claim 2, wherein the system orchestrator is external to the one or more autonomous mobile field equipment systems and the equipment transport system, and is configured to communicatively couple with each of the one or more autonomous mobile field equipment systems and the equipment transport system via at least one network connection.

9. The system of claim 1, wherein the one or more sets of task-based actuators are modular systems that are configured to be interchangeable.

10. The system of claim 1, wherein the deployment location comprises one of an agricultural site, an emergency site, a nature site, a recreational site, or an event venue, wherein the agricultural site includes at least one of an agricultural field, a farm, a plot of land, a ranch, an orchard, a crop field, or a sod field, wherein the emergency site includes one of a site of a natural disaster, an accident site, a hazardous waste spill site, or a search and rescue site, wherein the nature site includes one of a forest, a field, a meadow, an aquatic site, or an orbital site, wherein the recreational site includes one of a park, a plant garden, a flower garden, a plant nursery, a botanical garden, a residential lawn, a commercial lawn, a residential garden, a commercial garden, a greenway, or a recreational center, wherein the event venue includes one of a stadium, a concert hall, an arena, or a festival site.

11. A method, comprising:
instructing, by a computing system, an equipment transport system to traverse to a first deployment location from its current location;
instructing, by the computing system, the equipment transport system to deploy, within the first deployment location, one or more autonomous mobile field equipment systems that are loaded within the equipment transport system, after the equipment transport system has arrived at the first deployment location; and
instructing, by the computing system, each of the one or more autonomous mobile field equipment systems to perform a corresponding set of tasks, after being deployed to one or more portions of the first deployment location.

12. The method of claim 11, further comprising:
sending, by the computing system, one or more messages to at least one user device, the one or more messages including at least one of:
a first message for sending after the equipment transport system arrives at the first deployment location, the first message indicating that the equipment transport system has arrived at the first deployment location;
a second message for sending after the equipment transport system deploys the one or more autonomous mobile field equipment systems, the second message indicating that the one or more autonomous mobile field equipment systems have been deployed within the first deployment location;
a third message for sending after the computing system assigns the corresponding set of tasks to one of the one or more autonomous mobile field equipment systems, the third message indicating that the one of the one or more autonomous mobile field equipment systems has been assigned the corresponding set of tasks; or
a fourth message for sending after the computing system receives one or more task status updates from one of the one or more autonomous mobile field equipment systems, the fourth message including the one or more task status updates for the one of the one or more autonomous mobile field equipment systems.

13. The method of claim 11, wherein the set of tasks each includes at least one of an agriculture task, an emergency response task, a nature conservation task, a nature reclamation task, a nature maintenance task, a recreational area plant task, a recreational area plant watering task, a recreational area plant fertilizing task, a recreational area plant removal task, an object relocation task, a site cleanup task, or a waste removal task.

14. The method of claim 11, wherein the set of tasks includes a set of agriculture tasks including at least one of preparing for planting, planting, watering, fertilizing, harvesting, or removing one or more of a plurality of seeds or a plurality of plants, wherein the method further comprises instructing, by the computing system, a first autonomous mobile field equipment system among the one or more autonomous mobile field equipment systems to perform at least one agriculture task among the set of agriculture tasks, by sending at least one of:
one or more first instructions to prepare a first planting area within the first deployment location for planting, the one or more first instructions including instructions for:
moving a plurality of planting media to the first planting area; and
preparing each of the plurality of planting media for planting;
one or more second instructions to plant the one or more of the plurality of seeds or the plurality of plants in the first planting area within the first deployment location, the one or more second instructions including instructions for:
moving the one or more of the plurality of seeds or the plurality of plants to the first planting area;
creating a space within each corresponding portion of the plurality of planting media;
inserting the one or more of the plurality of seeds or the plurality of plants in corresponding created spaces of the plurality of planting media; and
covering gaps within the created spaces around the inserted one or more of the plurality of seeds or the plurality of plants;
one or more third instructions to water plants within the first planting area, the one or more third instructions including instructions for:
moving to the first planting area with a load of water; and
dispensing water to the one or more of the plurality of seeds or the plurality of plants that have been planted in the corresponding plurality of planting media;
one or more fourth instructions to fertilize plants within the first planting area, the one or more fourth instructions including instructions for:
moving to the first planting area with a load of fertilizer; and
dispensing fertilizer to the one or more of the plurality of seeds or the plurality of plants that have been planted in the corresponding plurality of planting media;
one or more fifth instructions to harvest plants within the first planting area, the one or more fifth instructions including instructions for:
moving to the first planting area;
harvesting harvestable portions of the one or more of the plurality of seeds or the plurality of plants based on a determination that the harvestable portions are ready for harvesting; and
moving the harvested harvestable portions to a harvest collection location for loading and transport from the first deployment location; or
one or more sixth instructions to remove dead, dying, or undesired plants from the first planting area, the one or more sixth instructions including instructions for:
moving to the first planting area;
identifying plants for removal from the first planting area;
moving to and extracting plants that have been identified for removal; and
moving the harvested harvestable portions to a harvest collection location for loading and transport from the first deployment location.

15. The method of claim 14, wherein the one or more of the plurality of seeds or the plurality of plants are planted in a plurality of straw bales, each straw bale being bundled together to form an integrated structure, wherein an outer surface of the integrated structure forms a container while a middle portion of the integrated structure decomposes to form the plurality of planting media.

16. The method of claim 11, wherein the set of tasks is performed using one or more modular and interchangeable sets of task-based actuators, wherein the method further comprises:
determining, by the computing system, whether a second autonomous mobile field equipment system is currently equipped with a set of task-based actuators that is capable of performing a currently assigned set of tasks; and
based on a determination that a currently equipped set of task-based actuators is not capable of performing the currently assigned set of tasks, instructing, by the computing system, an actuator exchange system to replace the currently equipped set of task-based actuators with a set of task-based actuators that is capable of performing the currently assigned set of tasks.

17. The method of claim 11, further comprising:
instructing, by the computing system, each of the one or more autonomous mobile field equipment systems to move to a field equipment docking station to dock with the field equipment docking station to recharge its field equipment power supply, based on a determination that its field equipment power supply is at a power level below a first predetermined threshold level.

18. The method of claim 11, further comprising:
instructing, by the computing system, each of the one or more autonomous mobile field equipment systems to return the equipment transport system for reloading, based on a determination that the set of tasks have been completed;
instructing, by the computing system, the equipment transport system to receive and load each of the one or more autonomous mobile field equipment systems; and
instructing, by the computing system, the equipment transport system to traverse from the first deployment location to one of a base location or a second deployment location.

19. An autonomous mobile field equipment system, comprising:
a field equipment propulsion system that is configured to propel the autonomous mobile field equipment system throughout a deployment location;
one or more sets of task-based actuators that are each configured to perform a set of tasks;
one or more field equipment sensors that are configured to collect sensor data;
a field equipment computing system that is configured to control and coordinate at least one of the field equipment propulsion system, the one or more sets of task-based actuators, or the one or more field equipment sensors;
a field equipment communications system that is configured to handle communications between the field equipment computing system and a system orchestrator; and
a field equipment power supply system that is configured to supply power to at least one of the field equipment propulsion system, the one or more sets of task-based actuators, the one or more field equipment sensors, the field equipment computing system, or the field equipment communications system.

20. The autonomous mobile field equipment system of claim 19, wherein the set of tasks comprises a set of agricultural tasks including at least one of preparing for planting, planting, watering, fertilizing, harvesting, or removing one or more of a plurality of seeds or a plurality of plants, wherein the one or more sets of task-based actuators are modular systems that are configured to be interchangeable.
